(19) United States
(12) Patent Application Publication
(10) Pub. No.: US 2013/0135297 A1
(43) Pub. Date: May 30, 2013

(54) DISPLAY DEVICE

(71) Applicant: Panasonic Liquid Crystal Display Co., Ltd., Hyogo (JP)

(72) Inventors: Takahiro KOBAYASHI, Osaka (JP); Yoshio UMEDA, Hyogo (JP)

(73) Assignee: Panasonic Liquid Crystal Display Co., Ltd., Hyogo (JP)

(21) Appl. No.: 13/687,409

(22) Filed: Nov. 28, 2012

(30) Foreign Application Priority Data
Nov. 29, 2011 (JP) 2011-260557

(51) Int. Cl. G06T 15/00; G06T 5/00

(52) U.S. Cl. CPC G06T 15/00; G06T 5/00
USPC 345/419; 345/589

(57) ABSTRACT

The present application discloses a video display device. The display device includes: a display surface with pixels. Each pixel has an opened sub-pixel including an opened filter having a color filter with an opening, an unopened sub-pixel having a color filter without an opening, and a liquid crystal driven in response to luminance for each of the opened and unopened sub-pixels; an input portion to which a video signal is input to define the video on the display surface; a signal generator for generating a luminance signal to define the luminance of the opened sub-pixel in response to the video signal; a detector for detecting a degree of change corresponding to a change between video frame images in response to the video signal; and an adjuster for adjusting the luminance of the opened sub-pixel defined by the video signal in response to the degree of change.

### BACKGROUND

1. Technical Field

The present application relates to a display device for displaying a video by means of liquid crystal.

2. Description of the Related Art

Techniques for displaying a video by driving liquid crystal have been widely applied to display devices. A display device generally includes a display surface formed of pixels and a backlight device for emitting light toward the display surface. Typically, each pixel includes a red sub-pixel having a color filter in correspondence with a red hue, a green sub-pixel having a color filter in correspondence with a green hue, and a blue sub-pixel having a color filter in correspondence with a blue hue. Light from the backlight device passes through these color filters and is emitted as a red light, a green light and a blue light from the display surface. Accordingly, a video is displayed on the display surface.

JP H11-295717 A discloses techniques for improving luminance of a video. According to JP H11-295717 A, if the display surface is formed of pixels each of which has a sub-pixel provided with a transparent layer in addition to the aforementioned sub-pixels, a bright video is displayed on the display surface. The techniques disclosed in JP H11-295717 A, however, involve a problem that additional processes are required to form the transparent layer.

JP 2011-100025 A proposes forming a through-hole in one of the red, green and blue color filters instead of forming the transparent layer. The techniques according to JP 2011-100025 A may improve the luminance of a video more easily than the techniques disclosed in JP H11-295717 A.

FIG. 18 is a schematic plan view showing an opened sub-pixel 910 formed according to the techniques disclosed in JP 2011-100025 A. FIG. 19 is a partial sectional view schematically showing the pixel 900 having the opened sub-pixel 910 shown in FIG. 18. The techniques disclosed in JP 2011-100025 A are described with reference to FIGS. 18 and 19.

As shown in FIG. 18, the opened sub-pixel 910 includes a blue color filter 912 formed with an opening 911. The opening 911 of the color filter 912 is formed by means of resist. The opening 911 is largely formed in order to increase transmittance of light from a backlight device (not shown).

In addition to the opened sub-pixel 910 shown in FIG. 18, FIG. 19 shows a red color sub-pixel 920 adjacent to the opened sub-pixel 910. The red color sub-pixel 920 includes a red color filter 922. Unlike the color filter 912 of the opened sub-pixel 910, the red color filter 922 is formed without an opening.

In addition to the aforementioned color filters 912 and 922, the pixel 900 includes a planarization layer 901 to form a planar surface, a liquid crystal layer 902, and a pair of glass plates 903 and 904 between which these are sandwiched. Since the color filter 912 of the opened sub-pixel 910 is formed with the opening 911, a gap formed by liquid crystal (i.e., the thickness of the liquid crystal layer 902) of the opened sub-pixel 910 is larger than that formed by liquid crystal of the red sub-pixel 920 formed without an opening.

In general, the gap formed by the liquid crystal is set within a range from 3 μm to 5 μm when the color filter is formed without an opening. For example, the gap formed by the liquid crystal increases by 0.5 μm to 1 μm if the color filter is formed with an opening.

It is known that an increase in the gap formed by the liquid crystal results in a slow response speed of the liquid crystal. Therefore, the liquid crystal of the opened sub-pixel 910 shown in FIG. 19 responds more slowly than the liquid crystal of the adjacent red sub-pixel 920.

If the display device displays a stereoscopic video, response delay of liquid crystal is perceived as crosstalk by the viewer. If the response speed of the liquid crystal is slow, the luminance of the pixel reaches a target luminance defined by a video signal with a delay from a timing at which the viewer views the video.

### SUMMARY

According to one aspect of the instant application, a display device including: a display surface formed of pixels each of which includes an opened sub-pixel including an opened filter having a color filter formed with an opening, an unopened sub-pixel having a color filter without an opening, and a liquid crystal to be driven in response to luminance set for each of the opened and unopened sub-pixels; an input portion to which a video signal is input to define a video displayed on the display surface; a signal generator configured to generate a luminance signal defining the luminance of the opened sub-pixel in response to the video signal; a detector configured to detect a degree of change in correspondence with a change between frame images of the video in response to the video signal; and an adjuster configured to adjust the luminance of the opened sub-pixel defined by the video signal in response to the degree of change.

The display device according to the instant application may appropriately display a video with high luminance.

The object, features and advantages of the present implementation will become more apparent from the following detailed description and the attached drawings.

### BRIEF DESCRIPTION OF THE DRAWINGS

FIG. 1 is a block diagram schematically showing a functional configuration of a display device according to the first embodiment;

FIG. 2 is a schematic perspective view of the display device shown in FIG. 1;

FIG. 3 is a schematic view showing a micro-region depicted on a display surface of the display device depicted in FIG. 2;

FIG. 4 is a schematic sectional view showing pixels in the micro-region depicted in FIG. 3;

FIG. 5 is a schematic view showing an exemplary object depicted in frame images of a video;

FIG. 6 is a conceptual view showing signal processes by a W signal generator of the display device shown in FIG. 1;

FIG. 7 is a conceptual and exemplary flowchart of gain data generating processes carried out by the W gain controller of the display device shown in FIG. 1;

FIG. 8A is a graph schematically showing gain data obtained in accordance with the flowchart represented in FIG. 7;

FIG. 8B is a graph schematically showing gain data obtained in accordance with the flowchart represented in FIG. 7;

FIG. 9A is a graph schematically showing gain data obtained in accordance with the flowchart represented in FIG. 7;

FIG. 9B is a graph schematically showing gain data obtained in accordance with the flowchart represented in FIG. 7;

FIG. 10 is a conceptual view showing signal processes by a multiplier of the display device depicted in FIG. 1;

FIG. 11 is a conceptual view showing signal processes by an RGB converter of the display device depicted in FIG. 1;

FIG. 12 is a block diagram schematically showing a functional configuration of a display device according to the second embodiment;

FIG. 13 is a view schematically showing frame images used for a stereoscopic video display;

FIG. 14A is a schematic view showing regional divisions of a display surface which switches a video display from a left frame image to a right frame image;

FIG. 14B is a schematic view showing regional divisions of a display surface which switches a video display from a right frame image to a left frame image;

FIG. 15 is a schematic flowchart of CT level data generating processes carried out by a CT level detector of the display device depicted in FIG. 12;

FIG. 16 is a conceptual and exemplary flowchart of gain data generating processes carried out by a W gain controller of the display device shown in FIG. 12;

FIG. 17 is a graph schematically showing gain data obtained in accordance with the flowchart represented in FIG. 16;

FIG. 18 is a schematic plan view of a conventional opened sub-pixel; and

FIG. 19 is a partial sectional view schematically showing a pixel having an opened sub-pixel shown in FIG. 18.

### DETAILED DESCRIPTION

Hereinafter, display devices according to various embodiments are described with reference to the drawings. It should be noted that similar reference numerals designate similar components throughout the following embodiments. For clarification of description, redundant explanations are omitted as appropriate. Structures, arrangements and shapes shown in the drawings and descriptions with reference to the drawings are only intended to make principles of the embodiments easily understood. Therefore, the principles of the embodiments are in no way limited thereto.

### First Embodiment

### (Configuration of Display Device)

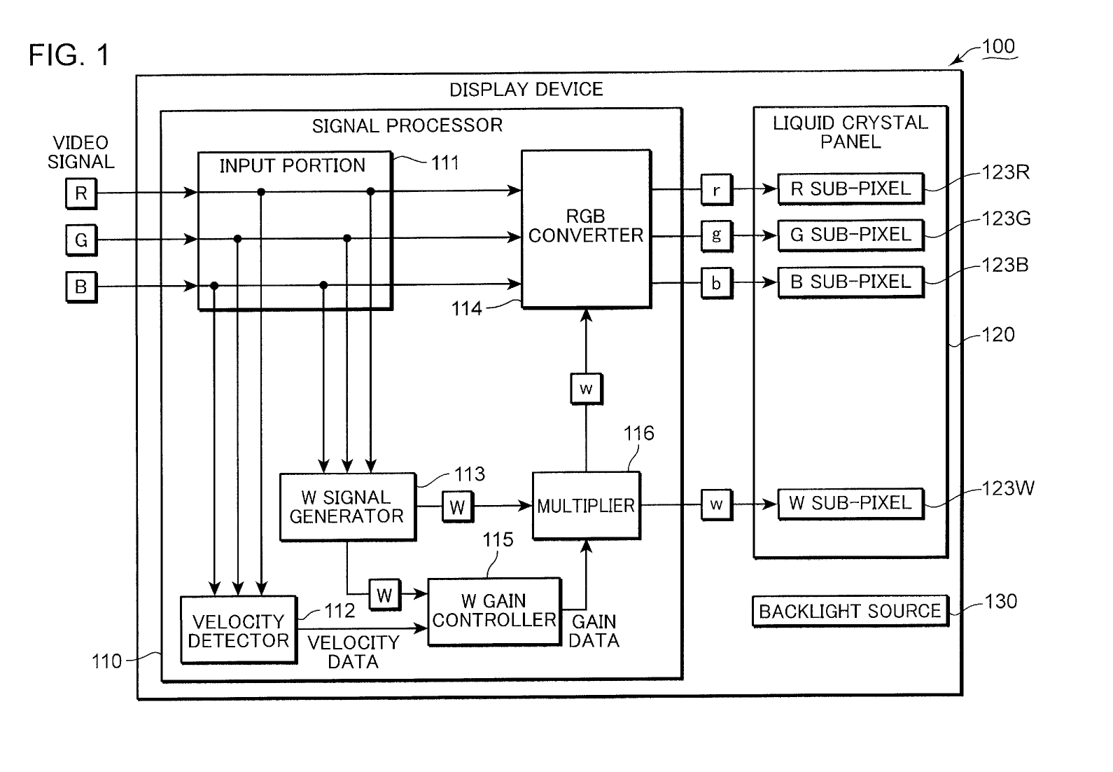

FIG. 1 is a block diagram schematically showing a functional configuration of the display device 100 according to the first embodiment. The display device 100 is described with reference to FIG. 1.

The display device 100 displays a video in response to a video signal. The video signal defines a tone (luminance) of a red hue, a tone (luminance) of a blue hue and a tone (luminance) of a green hue, pixel by pixel, to display the video. In the following description, the component of the video signal to define the luminance of the red hue is referred to as “R signal”. The component of the video signal to define the luminance of the green hue is referred to as “G signal”. The component of the video signal to define the luminance of the blue hue is referred to as “B signal”. In FIG. 1, these signals are designated by abbreviation using reference characters “R”, “G” and “B”.

The display device 100 includes a signal processor 110 configured to process the video signal. The signal processor 110 determines emission luminance of a white hue in response to the R, G and B signals. The signal processor 110 adjusts emission luminance of the red, green and blue hues in response to the determined luminance of the white light emission. The signal processor 110 then outputs luminance signals to define the emission luminance of these hues. In FIG. 1, the signals output from the signal processor 110 are designated by abbreviation using reference characters “r”, “g”, “b” and “w”. The signal designated by the reference character “r” is a signal to determine the luminance of the red hue. In the following description, this signal is referred to as “r signal”. The signal designated by the reference character “g” is a signal to define the luminance of the green hue. In the following description, this signal is referred to as “g signal”. The signal designated by the reference character “b” is a signal to define the luminance of the blue hue. In the following description, this signal is referred to as “b signal”. The signal designated by the reference character “w” is a signal to define the luminance of the white hue. In the following description, this signal is referred to as “w signal”. Configuration and operation of the signal processor 110 are described later.

The display device 100 further includes a liquid crystal panel 120 and a backlight source 130 which emits white light toward the liquid crystal panel 120. The liquid crystal of the liquid crystal panel 120 is driven in response to the output signals from the signal processor 110 (i.e., r, g, b and w signals). Accordingly, the liquid crystal panel 120 may modulate the light from the backlight source 130 in response to the output signals from the signal processor 110 to display a video.

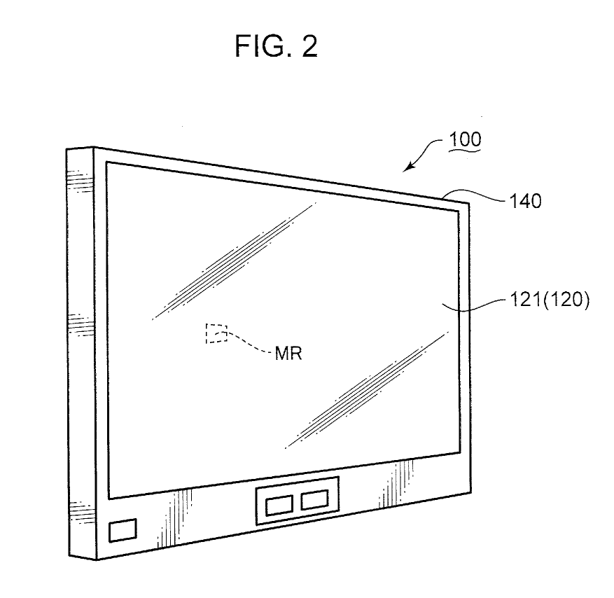

FIG. 2 is a schematic perspective view of the display device 100. The display device 100 is further described with reference to FIGS. 1 and 2.

The display device 100 further includes a housing 140 which stores and supports the signal processor 110, liquid crystal panel 120 and backlight source 130. The liquid crystal panel 120 includes a display surface 121 exposed from the housing 140. The display device 100 displays a video on the display surface 121 in response to the r, g, b and w signals.

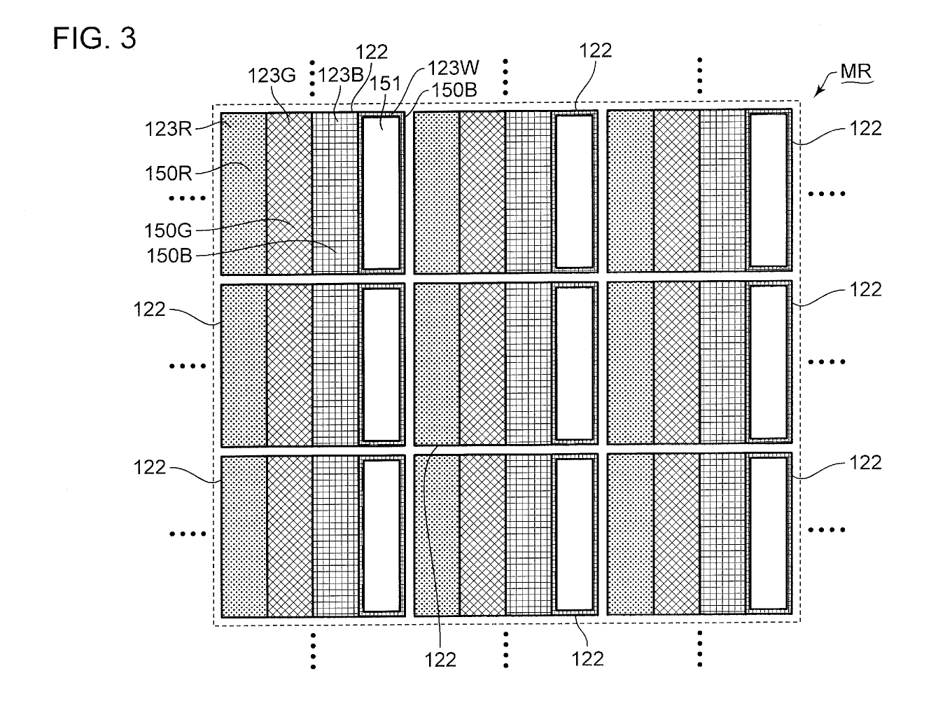

FIG. 3 is a schematic view of a micro-region MR encompassed by the dotted line on the display surface 121 shown in FIG. 2. The display device 100 is further described with reference to FIGS. 1 to 3.

The display device 100 includes a lot of pixels 122 arranged in a matrix over the display surface 121. Each of the pixels 122 includes a red sub-pixel, which emits a red light in response to the r signal (hereinafter, referred to as “R sub-pixel 123R”), a green sub-pixel, which emits a green light in response to the g signal (hereinafter, referred to as “G sub-pixel 123G”), a blue sub-pixel, which emits a blue light in response to the b signal (hereinafter, referred to as “B sub-pixel 123B”), and a white sub-pixel, which emits a white light in response to the w signal (hereinafter, referred to as “W sub-pixel 123W”).

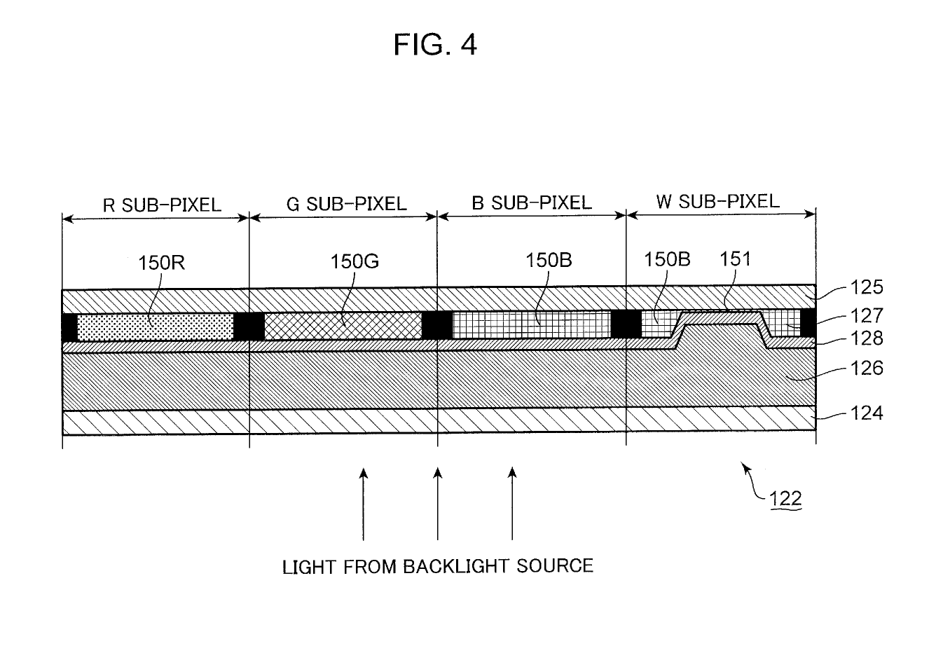

FIG. 4 is a schematic sectional view of the pixel 122. The pixel 122 is described with reference to FIGS. 1, 3 and 4.

The pixel 122 includes a first glass plate 124 which receives light from the backlight source 130, a second glass plate 125 substantially in parallel with the first glass plate 124, a liquid crystal layer 126 adjacent to the first glass plate 124, a color filter layer 127 adjacent to the second glass plate 125, and a planarization layer 128 formed between the liquid crystal layer 126 and the color filter layer 127. The R sub-pixel 123R includes a red color filter (hereinafter, referred to “R filter 150R”) which changes light from the backlight source 130 into transmitted light of the red hue. The G sub-pixel 123G includes a green color filter (hereinafter, referred to as “G filter 150G”) which changes light from the backlight source 130 into transmitted light of the green hue. The B sub-pixel 123B includes a blue color filter (hereinafter, referred to as “B filter 150B”) which changes light from the backlight source 130 into transmitted light of the blue hue. In the present embodiment, each of the R, G and B filters 150R, 150G, 150B is exemplified as the color filter.

As shown in FIG. 3, the W sub-pixel 123W includes the B filter 150B formed with an opening 151. The opening 151 largely occupies the B filter 150B so that a white light emitted from the backlight source 130 is emitted from the W sub-pixel 123W with few changes in hue. The B filter 150B of the W sub-pixel 123W is formed with the opening 151 whereas each of the R, G and B filters 150R, 150G, 150B of the R, G and B sub-pixels 123R, 123G, 123B is formed without an opening. The R, G and B filters 150R, 150G, 150B form the color filter layer 127.

In the present embodiment, the W sub-pixel 123W includes the B filter 150B which is formed with the opening 151. Alternatively, the white sub-pixel may include a red or green color filter formed with an opening.

In the present embodiment, the B filter 150B formed with the opening 151 is exemplified as the opened filter. The W sub-pixel 123W is exemplified as the opened sub-pixel. Each of the R, G and B sub-pixels 123R, 123G, 123B having the color filters (R, G and B filters 150R, 150G, 150B), which are formed without an opening, is exemplified as the unopened sub-pixel.

As shown in FIG. 4, the liquid crystal layer 126 includes liquid crystal situated in a region corresponding to the R sub-pixel 123R, liquid crystal situated in a region corresponding to the G sub-pixel 123G, liquid crystal situated in a region corresponding to the B sub-pixel 123B, and liquid crystal situated in a region corresponding to the W sub-pixel 123W. As shown in FIG. 1, the liquid crystal situated in the region corresponding to the R sub-pixel 123R is driven in response to the luminance set by the r signal. The liquid crystal situated in the region corresponding to the G sub-pixel 123G is driven in response to the luminance set by the g signal. The liquid crystal situated in the region corresponding to the B sub-pixel 123B is driven in response to the luminance set by the b signal. The liquid crystal placed in the region corresponding to the W sub-pixel 123W is driven in response to the luminance set by the w signal.

As shown in FIG. 4, a thickness of the liquid crystal layer 126 is substantially uniform throughout the R, G and B sub-pixels 123R, 123G, 123B. Since the B filter 150B of the W sub-pixel 123W is formed with the opening 151, the planarization layer 128 is protruded into the opening 151. Accordingly, the thickness of the liquid crystal layer 126 in the region formed with the opening 151 is larger than that of the liquid crystal layer 126 in the other regions. As a result of the increase in the thickness of the liquid crystal layer 126, the liquid crystal in the region of the liquid crystal layer 126 corresponding to the W sub-pixel 123W may show a slower response than the liquid crystal in the other regions when the regions of the liquid crystal layer 126 corresponding to the R, G, B and W sub-pixels 123R, 123G, 123B, 123W are subjected to an uniform voltage. The signal processor 110 described with reference to FIG. 1 takes the response delay of the liquid crystal of the W sub-pixel 123W into account to generate and output the r, g, b and w signals.

### (Signal Processor)

The signal processor 110 is described with reference to FIGS. 1 and 2.

The signal processor 110 includes an input portion 111, which is subjected to input of a video signal defining a displayed video on the display surface 121, a velocity detector 112, which detects a moving velocity of an object depicted in frame images of the video displayed on the display surface 121, a W signal generator 113, which outputs a W signal that is used for generation of the w signal, and an RGB converter 114, which generates and outputs the r, g and b signals in response to the video signal. As described above, the video signal includes the R, G and B signals. Each of the R, G and B signals is input to the velocity detector 112, W signal generator 113 and RGB converter 114 via the input portion 111. In the present embodiment, the moving velocity of the object depicted in frame images of the video is exemplified as the degree of change corresponding to a change between the frame images of the video. The velocity detector 112 is exemplified as the detector configured to detect the degree of change corresponding to the change between the frame images of the video.

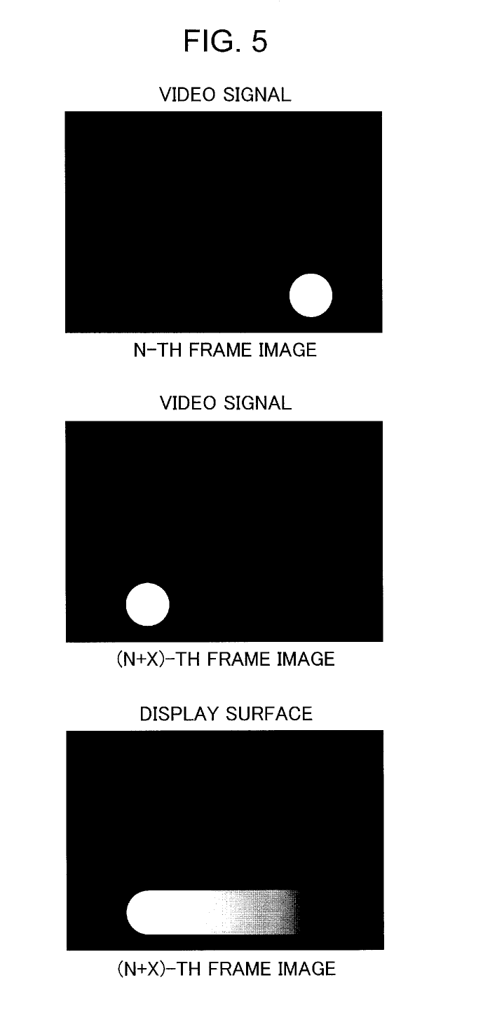

FIG. 5 is a schematic view of an exemplary object depicted in frame images of a video. The upper section of FIG. 5 shows a frame image which a video signal defines as “N-th” frame image. The intermediate section of FIG. 5 shows a frame image which the video signal defines as “(N+X)-th” frame image. The lower section of FIG. 5 shows a frame image displayed as “(N+X)-th” frame image on the display surface. It is described with reference to FIGS. 1, 4 and 5 how a moving velocity of an object affects a displayed image.

For clarification of description, in FIG. 5, the video signal defines a white object moving in a black background to the left from the N-th frame image to the (N+X)-th frame image. The white object is depicted mainly by light emission of the white sub-pixel. As described with reference to FIG. 4, the response of the liquid crystal of the white sub-pixel is relatively slow when the white sub-pixel includes a color filter formed with an opening. Therefore, the response of the liquid crystal of the white sub-pixel may not sufficiently catch up with a high moving velocity of the object. Accordingly, the object with a trail is displayed as shown in the lower section of the FIG. 5.

As shown in FIG. 1, the signal processor 110 further includes a W gain controller 115. The velocity detector 112 detects the moving velocity of the object depicted in frame images defined by the video signal. The velocity detector 112 may detect the moving velocity of the object by means of known motion vector detecting methods. The velocity detector 112 outputs data about the detected moving velocity of the object (hereinafter, referred to as “velocity data”) to the W gain controller 115. The W gain controller 115 generates gain data to adjust the emission luminance of the W sub-pixel 123W on the basis of the velocity data. In the present embodiment, the W gain controller 115 is exemplified as the adjuster.

In the present embodiment, the velocity detector 112 detects the moving velocity of the object, frame by frame. Alternatively, each frame image may be conceptually divided into several regions in order to detect the moving velocity of the object. If the velocity detector detects the moving velocity of the object every divided region, a calculation volume to detect the moving velocity may be decreased or the moving velocity of the object may be accurately detected. For example, the velocity detector may perform the calculations only for ticker portions in the frame images in order to detect the moving velocity of the object.

In the present embodiment, the W gain controller 115 calculates out gain data every frame. If the velocity detector detects the moving velocity of the object every divisional region, the W gain controller may calculate out gain data about each of the divisional regions.

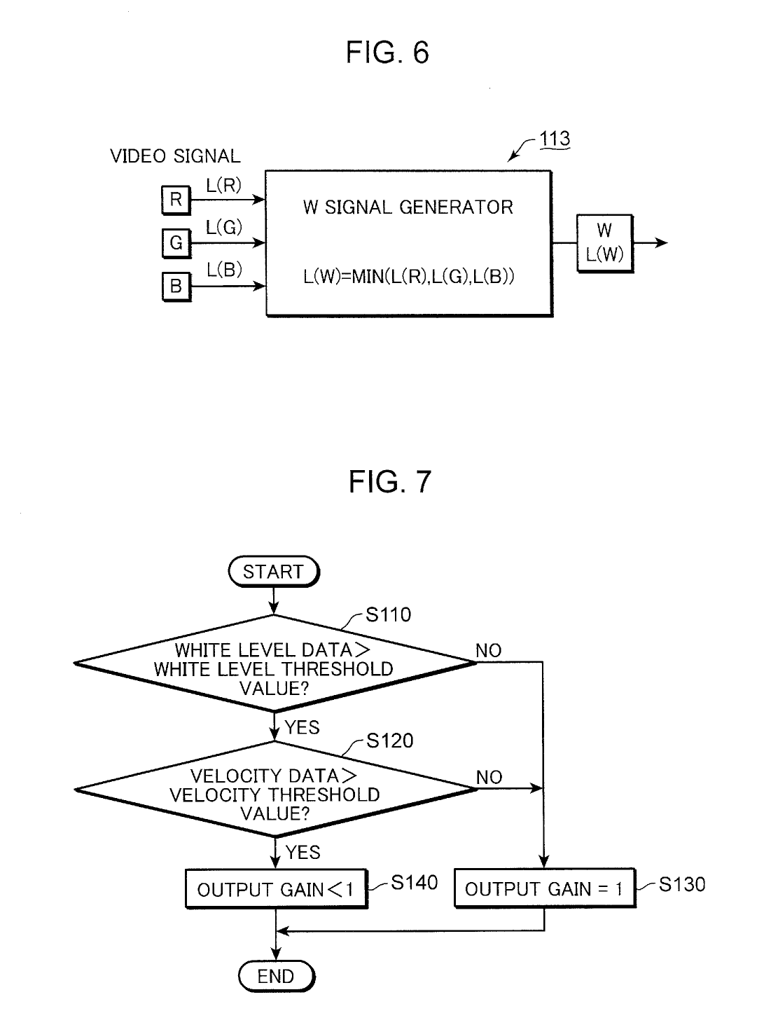

FIG. 6 is a conceptual view of signal processes by the W signal generator 113. The signal processes by the W signal generator 113 are described with reference to FIGS. 1, 5 and 6.

As shown in FIG. 1, the video signal is input to the W signal generator 113 via the input portion 111. The video signal includes the R, G and B signals. The W signal generator 113 determines “white level” defined by the video signal in response to the R, G and B signals.

In FIG. 6, the R signal defines luminance L(R). The G signal defines luminance L(G). The B signal defines luminance L(B). In the present embodiment, the W signal generator 113 determines the smallest value among the luminance L(R), L(G), L(B) as a white level L(W). Alternatively, the signal generator may determine the white level defined by the video signal by means of any other suitable methods.

The W signal generator 113 generates a W signal containing data about the white level L(W) (hereinafter, referred to as “white level data”), which is determined in response to the video signal, and then outputs the W signal to the W gain controller 115. The W gain controller 115 generates gain data on the basis of the velocity data and the white level data. In the present embodiment, the W signal is exemplified as the luminance signal which defines luminance of the opened sub-pixel. The W signal generator 113 is exemplified as the signal generator.

Unless the white level L(W) is adjusted by means of the gain data, a high value of the white level L(W) means that the W sub-pixel 123W emits light at high luminance. When the W sub-pixel 123W emits light at high luminance, there may be a noticeable degradation of a displayed video as described with reference to FIG. 5. Therefore, the W gain controller 115 according to the present embodiment generates the gain data on the basis of the velocity data and the white level data.

FIG. 7 is a conceptual and exemplary flowchart of gain data generating processes carried out by the W gain controller 115. The gain data generating processes are described with reference to FIGS. 1 and 7.

### (Step S110)

Once the velocity data generated by the velocity detector 112 and the W signal (white level data) generated by the W signal generator 113 are input to the W gain controller 115, step S110 is carried out. In the present embodiment, the W gain controller 115 stores a threshold value of the white level (hereinafter, referred to as “white level threshold value”) in advance. In step S110, the W gain controller 115 compares the input white level with the white level threshold value. If the white level data have a greater value than the white level threshold value, step S120 is carried out. If the white level data have a value no more than the white level threshold value, step S130 is carried out.

### (Step S120)

In the present embodiment, the W gain controller 115 stores a threshold value for the velocity of the object (hereinafter, referred to as “velocity threshold value”) in advance. In step S120, the W gain controller 115 compares the input velocity data with the velocity threshold value. If the velocity data have a greater value than the velocity threshold value, step S140 is carried out. If the velocity data have a value no more than the velocity threshold value, step S130 is carried out.

### (Step S130)

In step S130, the W gain controller 115 generates and outputs gain data having a value of “1”.

### (Step S140)

In step S140, the W gain controller 115 generates and outputs gain data having a value less than “1”.

In the present embodiment, the W gain controller 115 generates the gain data in accordance with the process shown in FIG. 7. Alternatively, the W gain controller may generate the gain data in accordance with any other suitable processes. For example, step S120 may be carried out simultaneously with or prior to step S110.

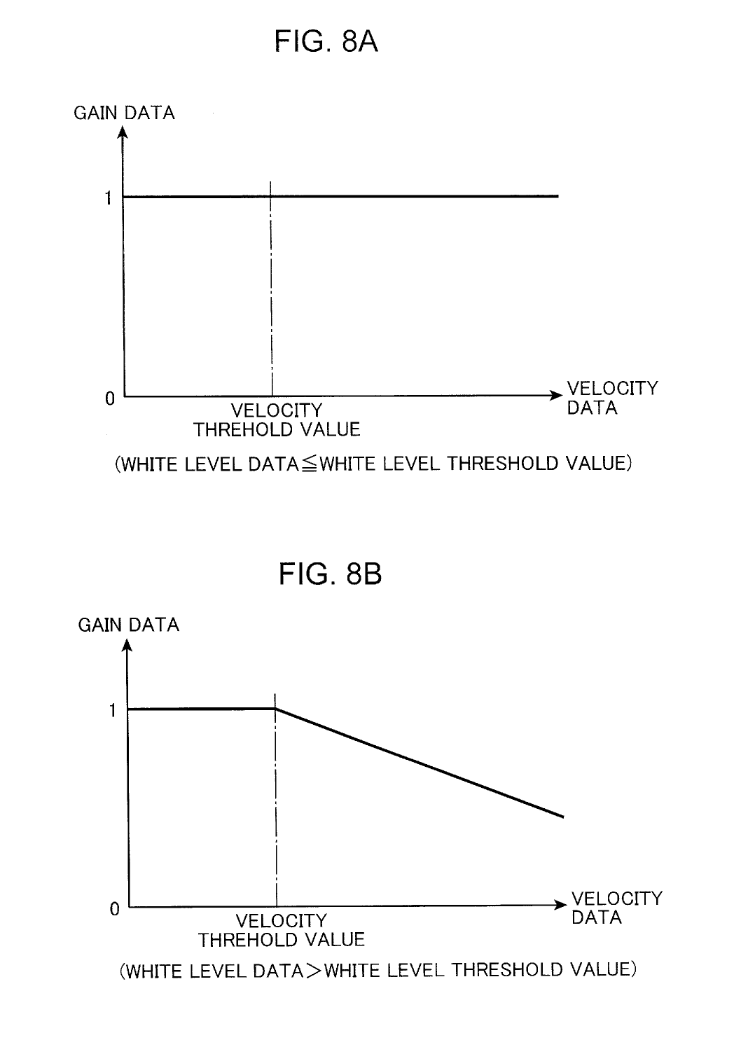

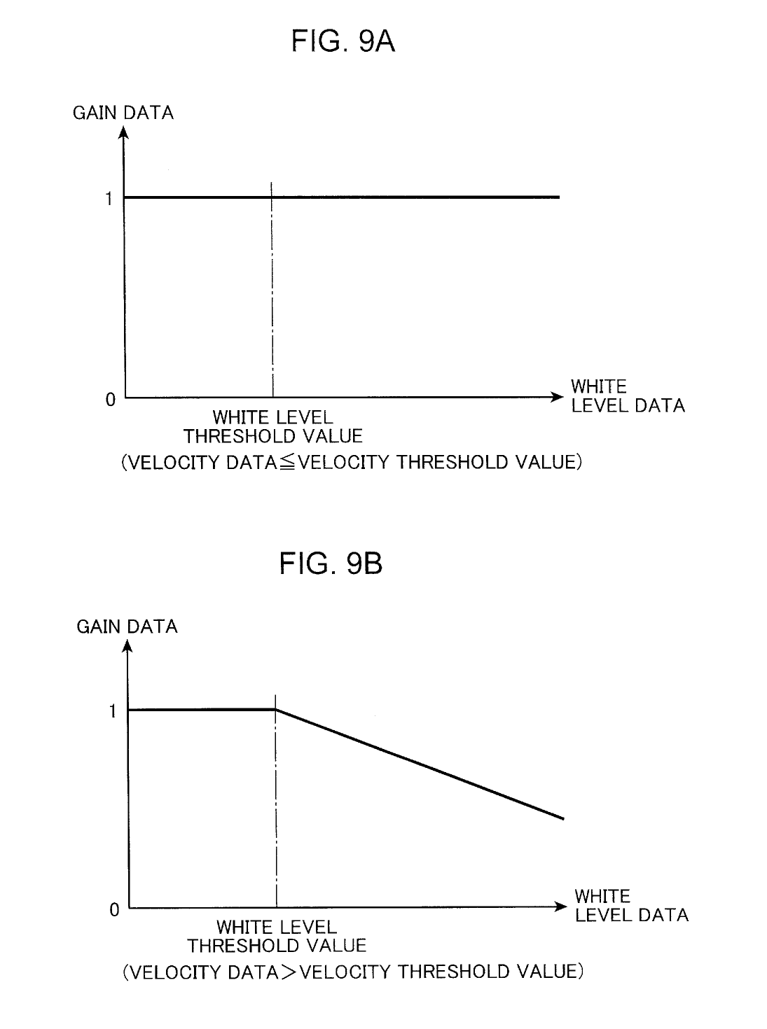

FIGS. 8A to 9B are graphs schematically showing gain data obtained in accordance with the flowchart shown in FIG. 7. The gain data generating processes are further described with reference to FIGS. 1, 7 to 9B.

FIG. 8A is a graph showing a relationship between the velocity data and the gain data which are obtained when the white level data have a value no more than the white level threshold value. FIG. 8B is a graph showing a relationship between the velocity data and the gain data which are obtained when the white level data have a greater value than the white level threshold value.

FIG. 9A is a graph showing a relationship between the white level data and the gain data which are obtained when the velocity data have a value no more than the velocity threshold value. FIG. 9B is a graph showing a relationship between the velocity data and the gain data which are obtained when the velocity data have a greater value than the velocity threshold value.

As described with reference to FIG. 7, when at least one of the values of the white level data and the velocity data is no more than the corresponding threshold value, step S130 is carried out. Therefore, the W gain controller 115 outputs gain data having a value of “1” independently from the value of the white level data or the velocity data when at least one of the values of the white level data and the velocity data is no more than the corresponding threshold value.

As described with reference to FIG. 7, when both values of the white level data and the velocity data are greater than the corresponding threshold values, step S140 is carried out. As shown in FIGS. 8B and 9B, in step S140, the W gain controller 115 may output gain data which have a smaller value as the value of the velocity data or white level data increases.

In the present embodiment, a velocity having a value no more than the velocity threshold value may be exemplified as the first velocity. A velocity having a greater value than the velocity threshold value may be exemplified as the second velocity.

In the present embodiment, a white level having a value no more than the white level threshold value may be exemplified as the first luminance. A white level having a greater value than the white level threshold value may be exemplified as the second luminance.

In the present embodiment, the W gain controller 115 uses the velocity threshold value and the white level threshold value as references to adjust the luminance of the W sub-pixel 123W defined by the W signal. Alternatively, the W gain controller may adjust the luminance of the white sub-pixel without relying upon these threshold values. For example, the W gain controller may be designed so that a value of output gain data decreases as a value of the velocity data increases over an entire range of input velocity data. Alternatively, the W gain controller may be designed so that a value of output gain data decreases as a value of the white level data increases over an entire range of input white level data.

As shown in FIG. 1, the signal processor 110 further includes a multiplier 116. The W signal generator 113 outputs the W signal to the multiplier 116 as well as the W gain controller 115. The W gain controller 115 outputs the gain data to the multiplier 116.

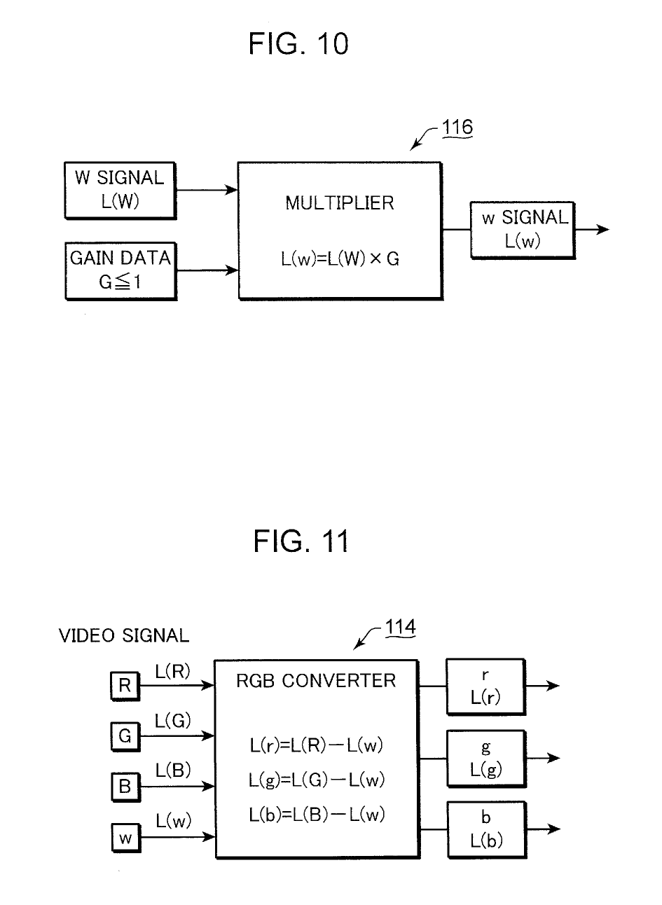

FIG. 10 is a conceptual view of signal processes by the multiplier 116. The signal processes by the multiplier 116 are described with reference to FIGS. 1 and 10.

As described above, the W signal output from the W signal generator 113 defines the luminance L(W). The W signal controller 115 outputs gain data G having a value no more than “1”. The multiplier 116 multiplies the luminance L(W) by the gain data G to determine a luminance L(w) for the W sub-pixel 123W. The multiplier 116 then outputs the w signal containing information about the determined luminance L(w) to the liquid crystal panel 120. The liquid crystal panel 120 drives the liquid crystal corresponding to the W sub-pixel 123W in response to the w signal.

FIG. 11 is a conceptual view showing signal processes by the RGB converter 114. The signal processes by the RGB converter 114 are described with reference to FIGS. 1, 3 and 11.

As shown in FIG. 1, the multiplier 116 outputs the w signal not only to the liquid crystal panel 120 but also to the RGB converter 114. The R, G and B signals are also input to the RGB converter 114 via the input portion 111.

As shown in FIG. 11, the R signal defines the luminance L(R). The G signal defines the luminance L(G). The B signal defines the luminance L(B). The w signal defines the luminance L(w). The RGB converter 114 subtracts the luminance L(w) from the luminance L(R) to determine luminance L(r) of the R sub-pixel 123R. The RGB converter 114 subtracts the luminance L(w) from the luminance L(G) to determine luminance L(g) of the G sub-pixel 123G. The RGB converter 114 subtracts the luminance L(w) from the luminance L(B) to determine luminance L(b) of the B sub-pixel 123B.

The RGB converter 114 generates and outputs the r signal containing information about the determined luminance L(r) to the liquid crystal panel 120. The liquid crystal panel 120 drives the liquid crystal corresponding to the R sub-pixel 123R in response to the r signal.

The RGB converter 114 generates and outputs the g signal containing information about the determined luminance L(g) to the liquid crystal panel 120. The liquid crystal panel 120 drives the liquid crystal corresponding to the G sub-pixel 123G in response to the g signal.

The RGB converter 114 generates and output the b signal containing information about the determined luminance L(b) to the liquid crystal panel 120. The liquid crystal panel 120 drives the liquid crystal corresponding to the B sub-pixel 123B in response to the b signal.

The RGB converter 114 may determine emitted color saturation of the pixel 122 on the basis of the R, G, B and w signals. When the determined saturation is lower than a predetermined value, a smaller value than the luminance L(w) may be subtracted from each of the luminance L(R), L(G), L(B). Accordingly, when the emitted color saturation of the pixel 122 is low, all of the R, G, B and W sub-pixels 123R, 123G, 123B, 123W emit light.

If the determined saturation is higher than a predetermined value, the gains of the r, g and b signals may be increased. Accordingly, even when the emitted color saturation of the pixel 122 defined by the R, G, B and w signals is high, the pixel 122 may emit light at high luminance.

### Second Embodiment

### (Configuration of Display Device)

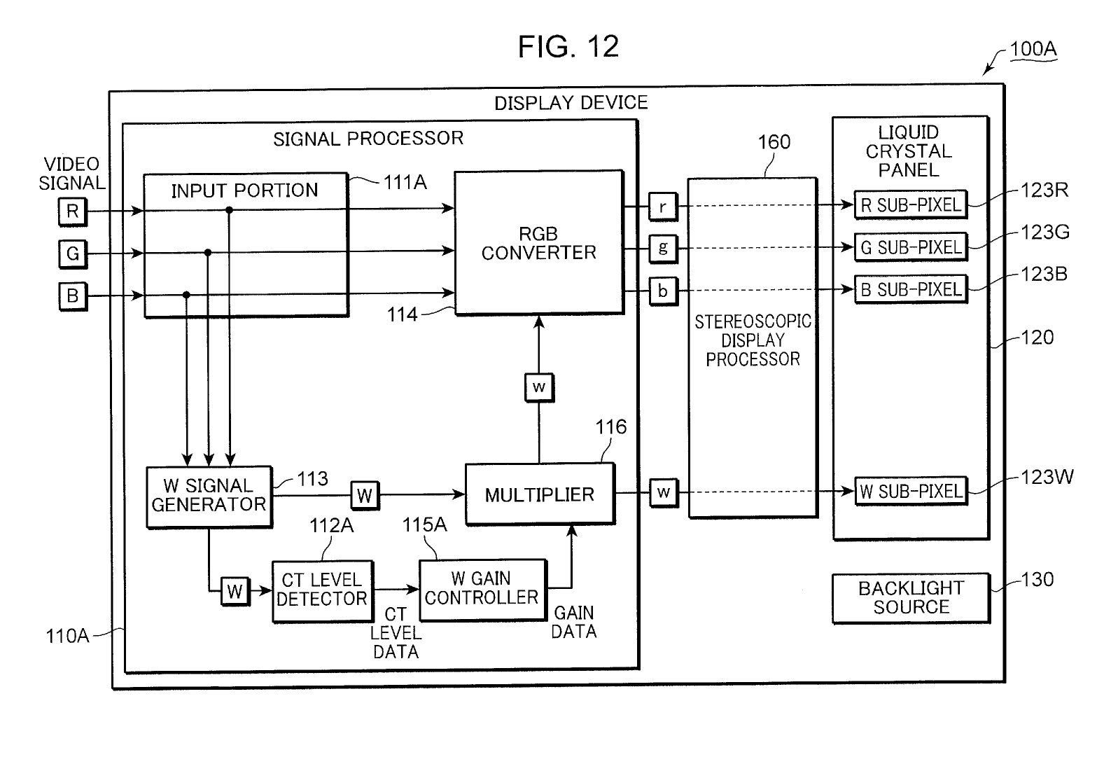

FIG. 12 is a block diagram schematically showing a functional configuration of the display device 100A according to the second embodiment. Differences between the display device 100A according to the second embodiment and the display device 100 according to the first embodiment are described. It should be noted that description about common elements between the display devices 100A and 100 is omitted.

Like the display device 100 according to the first embodiment, the display device 100A according to the second embodiment includes the liquid crystal panel 120 and the backlight source 130. The display device 100A further includes a signal processor 110A configured to generate and output the r, g, b and w signals in response to the video signal (including the R, G and B signals), and a stereoscopic display processor 160 configured to process these signals from the signal processor 110A for stereoscopic display. The r, g, b and w signals are output to the liquid crystal panel 120 via the stereoscopic display processor 160. The liquid crystal panel 120 drives the R, G, B and W sub-pixels 123R, 123G, 123B, 123W in response to the r, g, b and w signals which are appropriately processed by the stereoscopic display processor 160.

Like the signal processor 110 described in the context of the first embodiment, the signal processor 110A includes the W signal generator 113, RGB converter 114 and multiplier 116. The signal processor 110A further includes an input portion 111A which is subjected to input of the video signal. Unlike the input portion 111 described in the context of the first embodiment, the input portion 111A outputs the video signal to the W signal generator 113 and the RGB converter 114.

The signal processor 110A further includes a crosstalk level detector (hereinafter, referred to as “CT level detector 112A”). Like the first embodiment, the W signal generator 113 generates the W signal. The W signal is then output to the multiplier 116 and the CT level detector 112A. The CT level detector 112A detects a crosstalk level (hereinafter, referred to as “CT level”) in response to the W signal. The CT level detector 112A also generates crosstalk level data (hereinafter, referred to as “CT level data”) in response to the detected CT level. It is described later how to generate the CT level data.

The signal processor 110A further includes a W gain controller 115A. The CT level data are input from the CT level detector 112A to the W gain controller 115A. The W gain controller 115A generates gain data on the basis of the CT level data. Like the first embodiment, the gain data are input to the multiplier 116.

The multiplier 116 generates the w signal in accordance with the technologies described in the context of the first embodiment. Like the first embodiment, the w signal is output to the RGB converter 114. The w signal is also input to the liquid crystal panel 120 via the stereoscopic display processor 160.

The RGB converter 114 generates the r, g and b signals in accordance with the technologies described in the context of the first embodiment. The r, g and b signals are input to the liquid crystal panel 120 via the stereoscopic display processor 160.

The stereoscopic display processor 160 performs various processing operations to appropriately display a stereoscopic video. For example, the stereoscopic display processor 160 may adjust a frame rate to alternately display a left frame image, which is viewed by the left eye, and a right frame image, which is viewed by the right eye. In order to improve responsiveness of the liquid crystal, the stereoscopic display processor 160 may perform overdrive processes. The stereoscopic display processor 160 may perform various processing operations to prevent a video, in which left and right frame images are mixed, from being viewed (crosstalk cancelling operation). These operations may be performed in accordance with various known methods for stereoscopic video display. The processing operations performed by the stereoscopic display processor 160 are in no way limitative of principles of the present embodiment.

### <Principle of Crosstalk Generation>

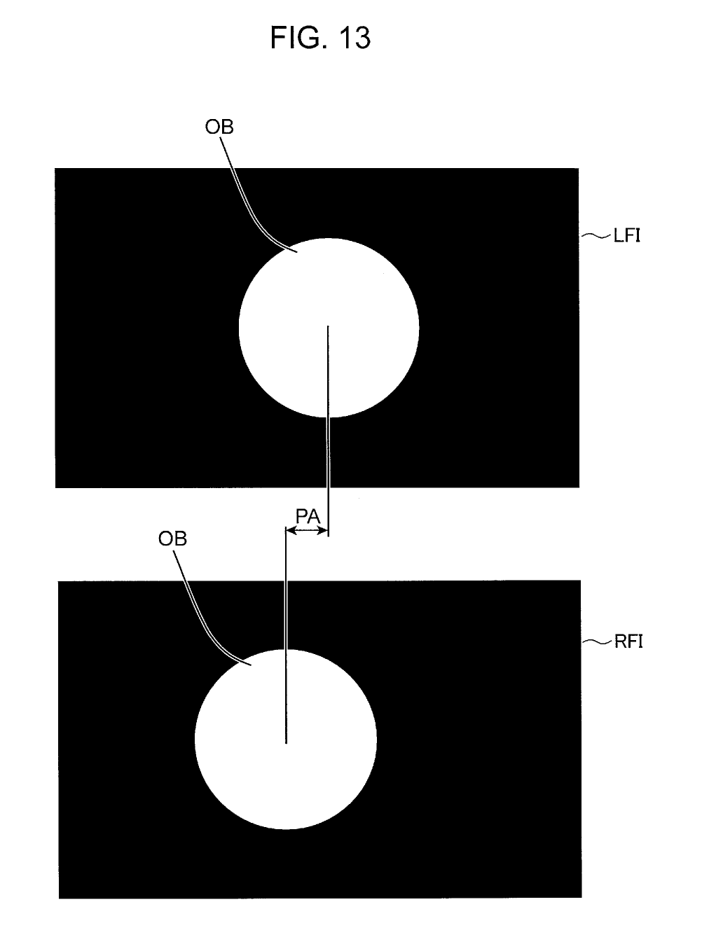

FIG. 13 schematically shows frame images used for stereoscopic video display. Principles of crosstalk generation are described with reference to FIG. 13.

Typically, a left frame image LFI and a right frame image RFI are alternately displayed for stereoscopic video display. FIG. 13 shows the left and right frame images LFI, RFI, each of which shows a black background (luminance level: 0%) and a white object OB (luminance level: 100%). There is a positional difference of the object OB on the display surface by a distance PA between the left and right frame images LFI, RFI. If a viewer views the left frame image LFI by the left eye and the right frame image RFI by the right eye, the viewer perceives a difference amount of the object OB by the distance PA and combines the left and right frame images LFI, RFI in the brain. Accordingly, the viewer perceives the object OB coming out or into the display surface.

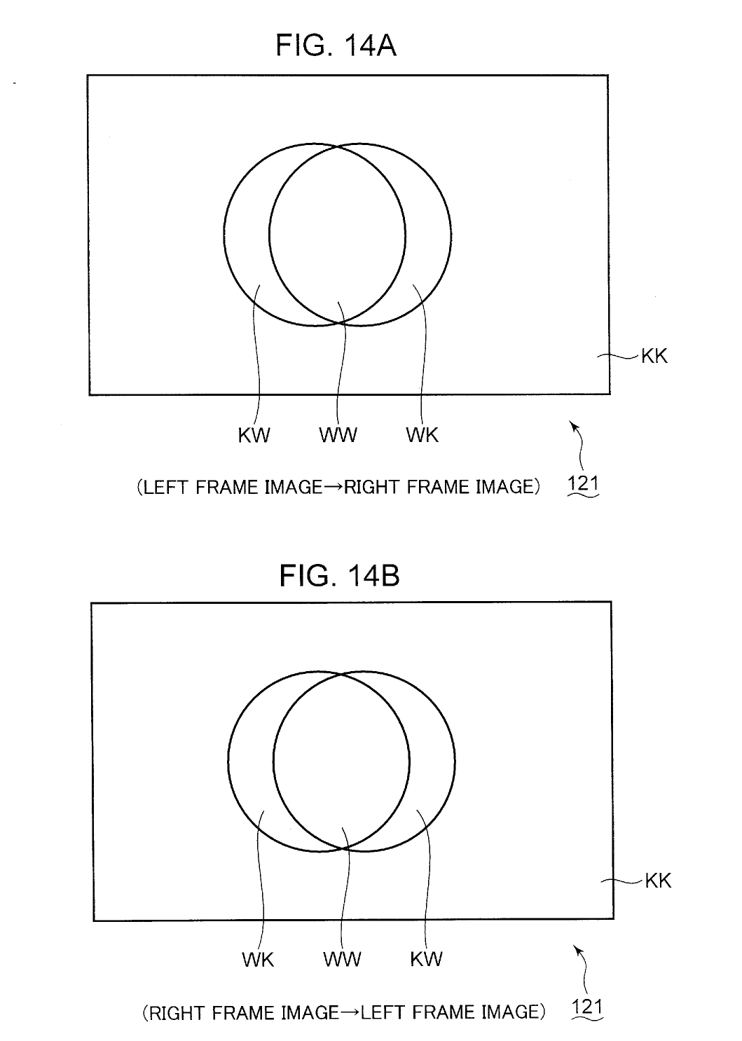

FIG. 14A is a schematic view showing regional divisions of the display surface 121 in which image display is switched from the left frame image LFI to the right frame image RFI. FIG. 14B is a schematic view showing regional divisions of the display surface 121 in which image display is switched from the right frame image RFI to the left frame image LFI. The principles of the crosstalk generation are further described with reference to FIGS. 4, 12 to 14B.

The display surface 121 is roughly divided into four regions on the basis of changes in luminance level which occur upon a switching operation of video display between the left and right frame images LFI, RFI. The region KK shown in FIGS. 14A and 14B maintains a luminance level of “0%” (black) during the switching operation of the video display. The region WW shown in FIGS. 14A and 14B maintains a luminance level of “100%” (white) during the switching operation of the video display. In the regions KW shown in FIGS. 14A and 14B, there is a change in luminance level from “0%” (black) to “100%” (white) as a result of the switching operation of the video display. In the regions WK shown in FIGS. 14A and 14B, there is a change in luminance level from “100%” (white) to “0%” (black) as a result of the switching operation of the video display.

Since the W sub-pixel 123W emits white light, the light emission of the W sub-pixel 123W contributes to display of an image portion having a high white level. Therefore, the W sub-pixel 123W emits light at a high luminance while the image portion having a high white level is displayed. The luminance of the W sub-pixel 123W then has to be lowered when the white level of the image portion is lowered as shown in FIGS. 14A and 14B. This requires that the liquid crystal of the W sub-pixel 123W have high responsiveness. However, as described with reference to FIG. 4, the response of the W sub-pixel 123W is relatively slow because the W sub-pixel 123W is formed by means of the B filter 150B formed with the opening 151.

When the viewer starts viewing a frame image, the regions WK have to display complete black (luminance level: 0%) ideally. However, as a result of the aforementioned delay in the response of the liquid crystal of the W sub-pixel 123W, it is difficult for the regions WK to display complete black (luminance level: 0%).

When the viewer starts viewing a frame image, the regions KW have to display complete white (luminance level: 100%) ideally. However, as a result of the aforementioned delay in the response of the liquid crystal of the W sub-pixel 123W, it is difficult for the regions KW to display complete white (luminance level: 100%).

The CT level detector 112A compares a preceding frame image with the subsequent frame image to generate the CT level data. The CT level data are calculated as a luminance difference in the same pixel 122. For example, if the central pixel 122 shown in FIG. 4 emits light at a luminance value of “70” during display of the preceding frame image and emits light at a luminance value of “50” during display of the subsequent frame image, a value of the CT level data calculated for the central pixel is “20”. The CT level detector 112A performs the aforementioned calculation for all the pixels 122 of the display surface 121 to generate the CT level data.

Since a response amount of the liquid crystal of the W sub-pixel 123W is reduced in response to the CT level data, the aforementioned crosstalk is less likely to occur. In the present embodiment, the CT level detector 112A deals with the left frame image as the preceding frame image and the right frame image as the subsequent frame image. Alternatively, the right frame image may be dealt as the preceding frame image whereas the left frame image may be dealt as the subsequent frame image. In the following description, the left frame image is exemplified as the first frame image. The right frame image is exemplified as the second frame image. The CT level detector 112A is exemplified as the detector.

### (Generation of CT Level Data)

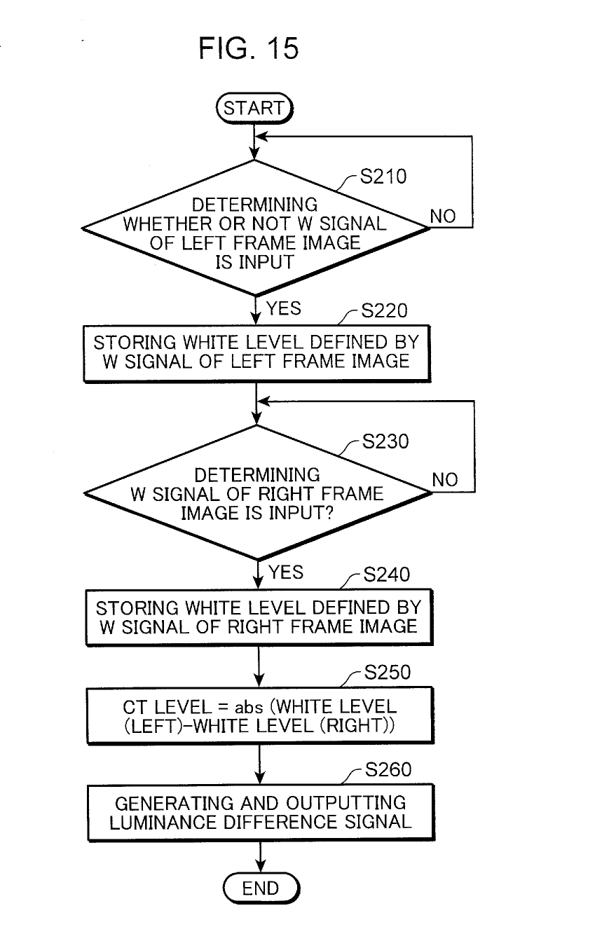

FIG. 15 is a schematic flowchart of a method for generating CT level data, which is carried out by the CT level detector 112A. The method for generating the CT level data is described with reference to FIGS. 12 and 15.

### (Step S210)

In order to generate the CT level data, step S210 is carried out at first. In step S210, the CT level detector 112A determines whether or not the W signal corresponding to the left frame image is input. The CT level detector 112A waits for input of the W signal corresponding to the left frame image. In response to the input of the W signal corresponding to the left frame image from the W signal generator 113 to the CT level detector 112A, step S220 is carried out. In the present embodiment, the W signal corresponding to the left frame image is exemplified as the first luminance signal.

### (Step S220)

The CT level detector 112A includes field memory. In step S220, the CT level detector 112A stores a white level defined by the W signal corresponding to the left frame image into the field memory. After the white level defined by the W signal corresponding to the left frame image is stored, step S230 is carried out.

### (Step S230)

In step S230, the CT level detector 112A determines whether or not the W signal corresponding to the right frame image is input. The CT level detector 112A waits for input of the W signal corresponding to the right frame image. In response to the input of the W signal corresponding to the right frame image from the W signal generator 113 to the CT level detector 112A, step S240 is carried out. In the present embodiment, the W signal corresponding to the right frame image is exemplified as the second luminance signal.

### (Step S240)

In step S240, the CT level detector 112A stores a white level defined by the W signal corresponding to the right frame image into the field memory. After the white level defined by the W signal corresponding to the right frame image is stored, step S250 is carried out.

### (Step S250)

In step S250, the CT level detector 112A calculates out an absolute value of a difference value between the white levels defined by the W signals corresponding to the left and right frame images. The W signals are output to each pixel 122 in the display surface 121. As described above, the CT level detector 112A calculates the luminance difference between the right and left frame images for the same pixel 122 as the CT level data. The CT level detector 112A performs the calculation about the luminance difference for all the pixels 122 of the display surface 121 to obtain the CT level data for every pixel 122 in the display surface 121. After the calculation about the CT level, step S260 is carried out.

### (Step S260)

In step S260, the CT level detector 112A generates and outputs a luminance difference signal containing data about the calculated CT level (CT level data) in step S250 for every pixel 122 in the display surface 121. In the present embodiment, the luminance difference signal is exemplified as the degree of change corresponding to a change between frame images of a video.

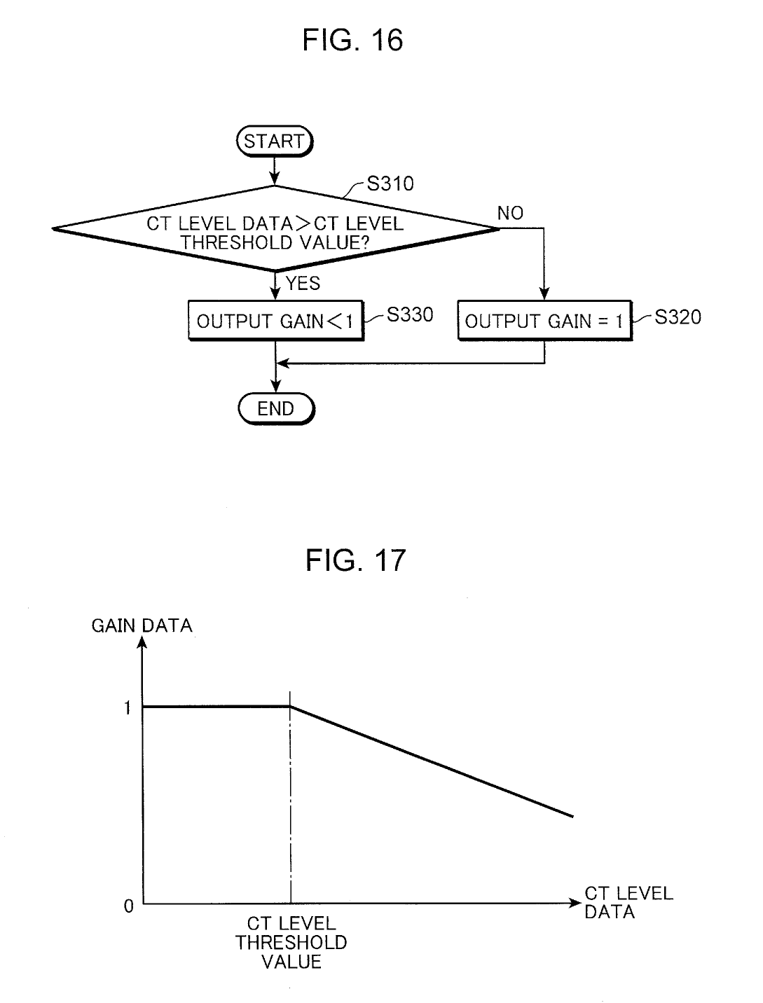

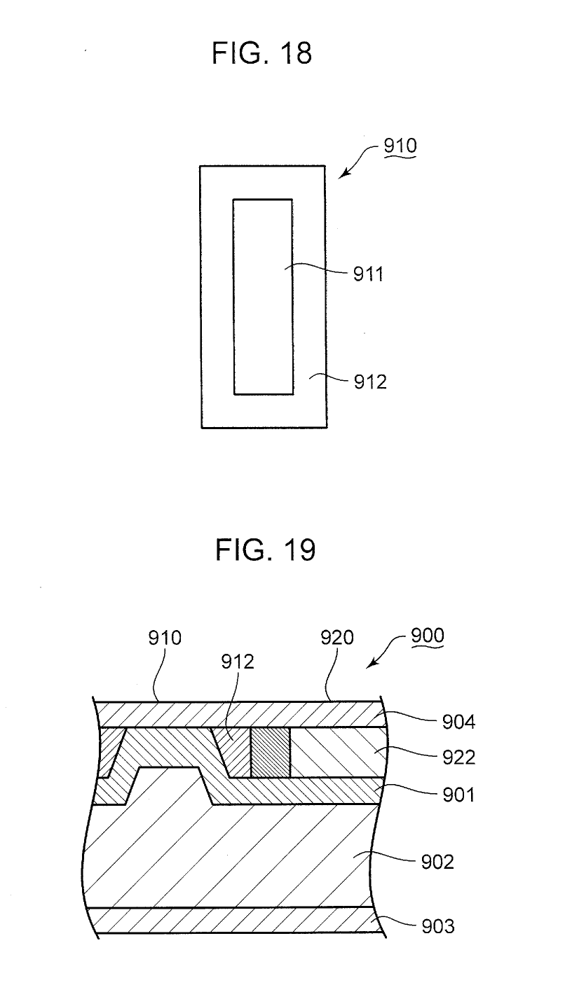

FIG. 16 is a conceptual and exemplary flowchart of gain data generating processes carried out by the W gain controller 115A. The gain data generating processes are described with reference to FIGS. 12 and 16.

### (Step S310)

In response to input of the CT level data generated by the CT level detector 112A to the W gain controller 115A, step S310 is carried out. In the present embodiment, the W gain controller 115A stores a threshold value of the CT level (hereinafter, referred to as “CT level threshold value”) in advance. In step S310, the W gain controller 115A compares the input CT level data with the CT level threshold value. The comparison between the CT level data and the CT level threshold value is performed for every pixel 122 in the display surface 121. If the value of the CT level data is more than the CT level threshold value, step S330 is carried out. If the value of the CT level data is no more than the CT level threshold value, step S320 is carried out.

### (Step S320)

In step S320, the W gain controller 115A generates and outputs gain data having a value of “1”.

### (Step S330)

In step S330, the W gain controller 115A generates and outputs gain data having a value less than “1”.

In the present embodiment, the W gain controller 115A generates gain data in accordance with the processes shown in FIG. 16. Alternatively, the W gain controller 115A may generate the gain data in accordance with any other suitable processes.

FIG. 17 is a graph schematically showing the gain data obtained in accordance with the flowchart depicted in FIG. 16. The gain data generating processes are further described with reference to FIGS. 10, 12, 16 and 17.

As described with reference to FIG. 16, if the value of the CT level data is more than the CT level threshold value, step S330 is carried out. In step S330, the W gain controller 115A may output gain data having a smaller value as a value of CT level data increases, as shown in FIG. 17.

In the present embodiment, the CT level no more than the CT level threshold value may be exemplified as the first luminance difference. The greater CT level than the CT level threshold value may be exemplified as the second luminance difference.

In the present embodiment, the W gain controller 115A uses the CT level threshold value as a reference to adjust the luminance of the W sub-pixel 123W defined by the W signal. Alternatively, the W gain controller may adjust the luminance of the white sub-pixel without relying upon the CT level threshold value. For example, the W gain controller may be designed so that the value of output gain data decreases as a value of the CT level data increases over the entire range of input CT level data.

As shown in FIG. 12, the W signal generator 113 outputs the W signal to the multiplier 116. The W gain controller 115A outputs the gain data to the multiplier 116. The multiplier 116 generates and outputs the w signal in accordance with the method described with reference to FIG. 10.

In the present embodiment, the gain data are calculated for each pixel. Alternatively, each frame image may be conceptually divided into several regions in order to calculate the gain data. Even when the gain data are calculated for each of the regions, the luminance of the white sub-pixel is adjusted appropriately. Optionally, the gain data may be calculated frame by frame. The principle of the present embodiment is in no way limited to specific calculation methods used for adjustment of the luminance of the white sub-pixel (e.g., the dividing method for data processes).

The principles of the aforementioned various embodiments may be utilized for a display device with a liquid crystal panel. The principles of the aforementioned embodiments are available for various systems for driving liquid crystal of a liquid crystal panel (e.g., In Plane Switching (IPS) system, Vertical Alignment (VA) system, and Twisted Nematic (TN) system).

The aforementioned specific embodiments mainly include a display device with the following features.

In one general aspect, the instant application describes a display device includes: a display surface formed of pixels each of which includes an opened sub-pixel including an opened filter having a color filter formed with an opening, an unopened sub-pixel having a color filter without an opening, and a liquid crystal to be driven in response to luminance set for each of the opened and unopened sub-pixels; an input portion to which a video signal is input to define a video displayed on the display surface; a signal generator configured to generate a luminance signal defining the luminance of the opened sub-pixel in response to the video signal; a detector configured to detect a degree of change in correspondence with a change between frame images of the video in response to the video signal; and an adjuster configured to adjust the luminance of the opened sub-pixel defined by the video signal in response to the degree of change.

According to the aforementioned configuration, the pixel forming the display surface to display a video includes the opened sub-pixel with the opened filter having the color filter formed with an opening, the unopened sub-pixel with the color filter without an opening, and the liquid crystal driven in response to luminance set for each of the opened and unopened sub-pixels. The signal generator generates the luminance signal to define the luminance of the opened sub-pixel in response to the video signal input to the input portion. Since the video is displayed by means of the opened sub-pixel including the opened filter having the color filter formed with the opening, the display device may display a bright video.

The detector detects the degree of change corresponding to a change between the frame images of the video in response to the video signal. The adjuster adjusts the luminance of the opened sub-pixel defined by the video signal in response to the degree of change. Therefore, a difference in response speed between the liquid crystals associated with the opened and unopened sub-pixels are reduced. Accordingly, the display device may display a high quality video.

The above general aspect may include one or more of the following features. The detector may detect a moving velocity of an object depicted in the frame images as the degree of change.

According to the aforementioned configuration, the detector detects the moving velocity of the object depicted in the frame images as the degree of change. Therefore, the display device may keep pace with the moving velocity of the object to display a high quality video.

If the object moves at a second velocity which is higher than a first velocity, the adjuster may set a lower gain than a gain of the luminance signal defined in correspondence to the first velocity.

According to the aforementioned configuration, the opened sub-pixel becomes less influential on a video during movement of the object at a relatively high velocity. Therefore, the display device may keep pace with the moving velocity of the object to display a high quality video.

If the luminance signal defines a second luminance, which is higher than a first luminance, for the opened sub-pixel, the adjuster may set a lower gain than a gain of the luminance signal defined in correspondence to the first luminance.

According to the aforementioned configuration, the adjuster sets a relatively low gain when the luminance signal defines a relatively high luminance. Therefore, the opened sub-pixel becomes less influential on the video. Accordingly, the display device may display a high quality video.

If the display surface displays a first frame image and a second frame image after the first frame image, the detector may compare luminance of the opened sub-pixel defined by a first luminance signal output from the signal generator in association with the first frame image with luminance of the opened sub-pixel defined by a second luminance signal output from the signal generator in association with the second frame image, and then may output a luminance difference signal in response to a luminance difference of the opened sub-pixel between the first and second luminance signals as the degree of change.

According to the aforementioned configuration, the second frame image is displayed on the display surface after the first frame image. The detector compares the luminance of the opened sub-pixel defined by the first luminance signal output from the signal generator in association with the first frame image with the luminance of the opened sub-pixel defined by the second luminance signal output from the signal generator in association with the second frame image. The detector outputs the luminance difference signal in correspondence with the luminance difference of the opened sub-pixel between the first and second luminance signals as the degree of change. Since the adjuster adjusts the luminance of the opened sub-pixel in response to the response speed required for the liquid crystal of the opened sub-pixel, the display device may display a high quality video.

If the luminance difference signal defines a second luminance difference which is larger than a first luminance difference, the adjuster may set a lower gain than a gain of the luminance signal defined in correspondence to the first luminance difference.

According to the aforementioned configuration, the adjuster sets a relatively low gain in response to a relatively large luminance difference. Therefore, the opened sub-pixel becomes less influential on the video. Accordingly, the display device may display a high quality video.

The first frame image is an image which may be viewed by one of right and left eyes whereas the second frame image is another image which may be viewed by another of the right and left eyes. A stereoscopic video may be displayed on the display surface by means of the first and second frame images.

According to the aforementioned configuration, the first frame image is viewed by one of the right and left eyes. The second frame image is viewed by the other eye. Therefore, the display device may display a stereoscopic video by means of the first and second frame images. Since the adjuster adjusts the luminance of the opened sub-pixel in response to the response speed required for the liquid crystal of the opened sub-pixel, the display device may appropriately display a stereoscopic video.

The liquid crystal of the opened sub-pixel may respond more slowly than the liquid crystal of the unopened sub-pixel.

According to the aforementioned configuration, the liquid crystal of the opened sub-pixel responds more slowly than that of the liquid crystal of the unopened sub-pixel. The detector detects the degree of change corresponding to a change between the frame images of the image in response to the video signal. The adjuster adjusts the luminance of the opened sub-pixel defined by the video signal in response to the degree of change. Since the difference in response speed between the liquid crystals of the opened and unopened sub-pixels is reduced, the display device may display a high quality video.

### INDUSTRIAL APPLICABILITY

The principles of the present embodiments are advantageously applicable to display devices by means of liquid crystal panels.

This application is based on Japanese Patent application No. 2011-260557 filed in Japan Patent Office on Nov. 29, 2011, the contents of which are hereby incorporated by reference.

Although the present application has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A display device comprising:
a display surface formed of pixels each of which includes an opened sub-pixel including an opened filter having a color filter formed with an opening, an unopened sub-pixel having a color filter without an opening, and a liquid crystal to be driven in response to luminance set for each of the opened and unopened sub-pixels;
an input portion to which a video signal is input to define a video displayed on the display surface;
a signal generator configured to generate a luminance signal defining the luminance of the opened sub-pixel in response to the video signal;
a detector configured to detect a degree of change in correspondence with a change between frame images of the video in response to the video signal; and
an adjuster configured to adjust the luminance of the opened sub-pixel defined by the video signal in response to the degree of change.

2. The display device according to claim 1, wherein the detector detects a moving velocity of an object depicted in the frame images as the degree of change.

3. The display device according to claim 2, wherein if the object moves at a second velocity which is higher than a first velocity, the adjuster sets a lower gain than a gain of the luminance signal defined in correspondence to the first velocity.

4. The display device according to claim 2, wherein if the luminance signal defines a second luminance, which is higher than a first luminance, for the opened sub-pixel, the adjuster sets a lower gain than a gain of the luminance signal defined in correspondence to the first luminance.

5. The display device according to claim 1, wherein if the display surface displays a first frame image and a second frame image after the first frame image, the detector compares luminance of the opened sub-pixel defined by a first luminance signal output from the signal generator in association with the first frame image with luminance of the opened sub-pixel defined by a second luminance signal output from the signal generator in association with the second frame image, and then outputs a luminance difference signal in response to a luminance difference of the opened sub-pixel between the first and second luminance signals as the degree of change.

6. The display device according to claim 5, wherein if the luminance difference signal defines a second luminance difference which is larger than a first luminance difference, the adjuster sets a lower gain than a gain of the luminance signal defined in correspondence to the first luminance difference.

7. The display device according to claim 5,
wherein the first frame image is an image which is viewed by one of right and left eyes whereas the second frame image is another image which is viewed by another of the right and left eyes; and
a stereoscopic video is displayed on the display surface by means of the first and second frame images.

8. The display device according to claim 1, wherein the liquid crystal of the opened sub-pixel responds more slowly than the liquid crystal of the unopened sub-pixel.
